(19) United States
(12) Patent Application Publication
(10) Pub. No.: US 2018/0239783 A1
(43) Pub. Date: Aug. 23, 2018

(54) METHOD, TERMINAL AND SYSTEM FOR SEARCHING ON-THE-WAY TARGET PICTURE

(71) Applicant: BEIJING QIHOO TECHNOLOGY COMPANY LIMITED, Beijing (CN)

(72) Inventor: Dangwei WEI, Beijing (CN)

(73) Assignee: BEIJING QIHOO TECHNOLOGY COMPANY LIMITED, Beijing (CN)

(21) Appl. No.: 15/753,466

(22) PCT Filed: Dec. 24, 2015
(86) PCT No.: PCT/CN2015/098795

§ 371 Date: Feb. 19, 2018

(30) Foreign Application Priority Data
Aug. 18, 2015 (CN) 201510509294.5

(51) Int. Cl. G06F 17/30

(52) U.S. Cl. CPC G06F 17/30268; G06F 17/3087; G06F 17/3089; G06F 17/30554; G06F 17/3028

(57) ABSTRACT

The present invention relates to the field of computer network technologies, and more particularly, to a method, a terminal and a system for searching an on-the-way target picture. A server and a method for searching an on-the-way target picture used in the server are provided. The method comprises: receiving a picture search request including road information and a direction of travel; searching to obtain a plurality of target pictures matching both the road information and the direction of travel; processing the plurality of target pictures according to different geographic locations included in the road information to obtain picture data sorted according to variation of the geographic locations along the direction of travel of the road; and pushing the picture data in response to the search request.

### FIELD OF TECHNOLOGY

The present invention relates to the field of computer network technologies, and more particularly, to a method, a terminal and a system for searching an on-the-way target picture.

### BACKGROUND

With the rapid development of mobile terminal devices and network technologies, types and functions of the mobile terminal devices become increasingly rich. Currently, a majority of the mobile terminals can be connected to remote servers to search, browse and download pictures on the servers.

However, in the prior art, when pictures in a server are searched through picture feature information, what is returned to the mobile terminal is nothing but pictures matching the feature information, and no richer picture processing function is provided. Consequently, the user experience in browsing pictures is reduced. Meanwhile, pictures returned to the user are nothing but thumbnails of a plurality of pictures sorted only according to time or place. By clicking on one of the thumbnails, the user can view an enlarged picture of the single thumbnail, but cannot continuously browse data of a plurality of pictures sequentially changing with geographic locations. Therefore, it is inefficient to browse a plurality of target pictures.

### SUMMARY

An objective of the present invention is intended to solve at least one of the above problems by providing a method, a terminal and a system for searching on-the-way target picture.

To achieve this objective, the present invention adopts the following technical solutions.

The present invention provides a method for searching an on-the-way target picture, comprising following steps:

receiving a picture search request including road information and a direction of travel;
searching to obtain a plurality of target pictures matching both the road information and the direction of travel;
processing the plurality of target pictures according to different geographic locations included in the road information to obtain picture data sequentially sorted according to variation of the geographic locations along the direction of travel of the road; and
pushing the picture data in response to the search request.

The present invention also provides a method for searching an on-the-way target picture used in a mobile terminal, comprising following steps:

sending a picture search request including road information and a direction of travel via a remote interface;
receiving, via the remote interface, picture data returned by a server and sorted according to variation of different geographic locations included in the road information; and
displaying the returned picture data, wherein the picture data are sequentially displayed along the direction of travel of the road.

The present invention also provides a server, comprising:

a receiving module, configured to receive a picture search request including road information and a direction of travel;
a search module, configured to search to obtain a plurality of target pictures matching both the road information and the direction of travel;
a picture processing module, configured to process the plurality of target pictures according to different geographic locations included in the road information to obtain picture data sorted according to variation of the geographic locations along the direction of travel of the road; and
a pushing module, configured to push e picture data in response to the search request.

The present invention also provides a mobile terminal, comprising: a sending module, configured to send a picture search request including road information and a direction of travel via a remote interface;

a second receiving module, configured to receive, via the remote interface, picture data returned by a server and sorted according to variation of different geographic locations included in the road information; and

a display module, configured to display the returned picture data, wherein the picture data are sequentially displayed along the direction of travel of the road.

The present invention also provides a system for searching an on-the-way target picture, comprising: a mobile terminal and a server.

The server is the system for searching an on-the-way target picture.

The mobile terminal is the mobile terminal for searching and displaying an on-the-way target picture.

The present invention also discloses a computer program, comprising a computer-readable code, wherein when an intelligent electronic device runs the computer-readable code, the method is caused to be performed.

The present invention also discloses a computer-readable medium, in which the foregoing computer program is stored.

Compared with the prior art, the present invention have following advantages.

1. In the present invention, a user sends, via a remote interface of the mobile terminal, a picture search request including road information and a direction of travel to a server. The server processes the plurality of target pictures matching the road information and the direction of travel according to different geographic locations included in the road information to obtain picture data sorted according to variation of the geographic locations along the direction of travel of the road. The mobile terminal displays the picture data pushed by the server. That is, the picture data are sequentially displayed along the direction of travel of the road. After a plurality of pictures along a certain direction of travel of a certain road are screened and sorted by a server, data of a plurality of target pictures sequentially changing along the direction of travel of the road can be efficiently browsed on the mobile terminal. In this way, continuity of picture browsing in variation of the geographic locations is implemented, a more real browsing effect of on-the-way sceneries is achieved, and visual perception of the user is enriched.

2. The picture search request sent by the mobile terminal may further comprise time information and picture classification information. A more precise picture search function is provided for the user, thereby facilitating the user to precisely search a target picture and improving a retrieval efficiency.

3. When receiving a picture including picture feature information and storing the picture into the picture database, the server stores the picture using an extracted MD value of the picture as a picture name. Because different pictures have different MD5 values, using the MD5 values of the pictures as the file names of pictures can prevent the server from storing too many duplicate pictures and thus increasing the burden of the server in storing and searching pictures. Therefore, limited storage space is saved, and the picture search efficiency is improved.

4. When processing a plurality of target pictures of the same geographic location, the plurality of target pictures are deduplicated and spliced to obtain a panoramic picture corresponding to the geographic location. A plurality of pictures where the same geographic location comprises a part of identical picture contents are deduplicated and spliced to obtain a panoramic picture. That is, more useful picture information is displayed within limited space and time. In this way, redundancy of information of a plurality of pictures comprising the same contents of the same geographic location is reduced for the user, the efficiency of browsing the plurality of pictures is improved for the user, and an ideal target picture browsing effect is achieved.

5. The road information and the direction of travel included in the on-the-way target picture search request of the mobile terminal may be extracted from GPS information of the mobile terminal, wherein a road region where a region, from the current GPS geographic location, between a first distance and a second distance preset in front along the direction of travel of the terminal is positioned is the road information. That is, an intelligent terminal moving along a certain direction of travel can search, in real time, on-the-way scenery information of a road ahead, such that the user can see on-the-way sceneries ahead in advance, thereby further improving the user experience.

Additional aspects and advantages of the present invention will be set forth in the description which follows and will be apparent from the description, or may be learned by practice of the present invention.

### BRIEF DESCRIPTION OF THE DRAWINGS

The above and/or additional aspects and advantages of the present invention will become apparent and readily comprehensible from the following description of embodiments with reference to the accompanying drawings, in which,

FIG. 1 is a program flow chart of a method for searching an on-the-way target picture used in a server according to an embodiment of the present invention;

FIG. 2 is a program flow chart of a method for searching an on-the-way target picture used in a server according to another embodiment of the present invention;

FIG. 3 is a program flow chart of a method for searching an on-the-way target picture used in a mobile terminal according to an embodiment of the present invention;

FIG. 4 is a structure block diagram of a server according to an embodiment of the present invention;

FIG. 5 is a structure block diagram of a picture processing module in the server according to an embodiment of the present invention;

FIG. 6 is a structure block diagram of a mobile terminal according to an embodiment of the present invention;

FIG. 7 is a structure block diagram of a system for searching an on-the-way target picture according to the present invention;

FIG. 8 illustrates a block diagram of an intelligent electronic device for performing the method according to the present invention; and

FIG. 9 illustrates a schematic diagram of a memory cell for maintaining or carrying a program code for implementing the method according to the present invention.

### DESCRIPTION OF THE EMBODIMENTS

In the following, the present invention is further described with reference to the accompanying drawings and exemplary embodiments. Examples of the embodiments are as shown in the accompanying drawings, in which same or similar reference numbers always represent same or similar elements or elements with same or similar functions. The embodiments described with reference to the drawings are exemplary, just used for explaining the present invention, not for limiting the present invention. In addition, detailed description of the prior art is omitted if it is unnecessary to features illustrating the present invention.

A person skilled in the art may understand that “a”, “an” “said” and “the” used herein may also refer to plural forms, unless otherwise specifically stated. It should be further understood that, phraseology “comprise” used in the specification of the present invention refers to the presence of the characteristics, integers, steps, operations, elements and/or components, but not exclusive of the presence or addition of one or more other characteristics, integers, steps, operations, elements, components and/or groups thereof. It should be understood that when we mention that an element is “connected” or “coupled” to another element, it may be directly connected or coupled to the other elements, or intermediate elements may be available. In addition, “connection” or “coupling” used herein may include wireless connection or coupling. The phraseology “and/or” includes any one unit and all combinations of one or more associated listed items.

A person skilled in the art may understand that, unless otherwise defined, all terms (including technical terms and scientific terms) used herein have the same meaning as commonly understood by an ordinary person skilled in the art to which the present invention belongs. It should also be understood that terms such as those defined in commonly used dictionaries should be interpreted as having a meaning that is consistent with their meaning in the context of the prior art, and will not be interpreted in an idealized or overly formal sense unless expressly so defined herein.

Those skilled in the art may understand that the “terminal” or “terminal device” used herein not only comprises a device of a wireless signal receiver, which is a device of a wireless signal receiver having no emission capability, but also comprises a device of a receiving and emitting hardware, which is a device of a receiving and emitting hardware performing two way communications on a two-way communications link. The devices may comprise: cellular or other communications devices, which are cellular or other communications devices having single-line displays or multi-line displays or having no multi-line displays; personal communications service (PCS), which may combine voice, data processing, faxing and/or data communications capability; personal digital assistant (PDA), which may comprise a radio frequency receiver, a pager, an Internet/Intranet access, a web browser, a notepad, a calendar and/or a global positioning system (GPS) receiver; and a conventional laptop and/or palmtop computer or other devices, which are a conventional laptop and/or palmtop computer or other devices having and/or comprising radio frequency receivers. The “terminal” or “terminal device” used herein may be portable, transportable, installed in a transportation means (air transportation, marine transportation and/or land transportation), or adapted to and/or configured to operate locally, and/or operate, in a distributed way, at any other location on earth and/or space. The “terminal” and “terminal device” used herein may also be a communication terminal, an Internet surfing terminal, a music/video player terminal, for example, a PDA, a mobile Internet device (MID), and/or a mobile phone having music/video playback function, or may be a smart television, a set-top box, and the like.

Those skilled in the art may understand that the concepts of servers, cloud and remote network devices used herein have the equivalent effect, comprising but not limited to computers, network hosts, a single network server, a plurality of network server sets, or cloud composed of a plurality of servers. The cloud herein is composed of a large number of computers or network servers based on cloud computing, wherein the cloud computing is one type of distributed computing, which is a super virtual computer formed by a cluster of computer sets loosely coupled. In the embodiments of the present invention, communications among the remote network device, the terminal device and a WNS server may be implemented by any communication mode, comprising but not limited to, mobile communication based on 3GPP, LIE, WIMAX, computer network communication based on TCP/IP and UDP protocols, and short distance wireless transmission based on Bluetooth and infrared transmission standards.

It is necessary to make the following guiding introduction to the application scenarios and principles of the present invention in advance.

The Internet generally comprises a client (the user's mobile terminal), a network and a server (such as a web server of a website). The client may be the user's Internet mobile terminal, for example, a desktop computer (PC), a laptop computer, a smart device with a web browsing function such as a personal digital assistant (PDA) and a mobile Internet device (MID), and a smart phone, etc. These mobile terminals may request, in a network environment (typically in the Internet environment), another process (such as a server-provided process) to provide a certain service. For example, in the present invention, a picture search request carrying picture feature information is sent to the server via the mobile terminal, and processed target picture data returned by the server are received.

The server generally is a remote computer system that is accessible through a communication medium, for example, the Internet typically. Moreover, generally the server can provide services for a plurality of clients from the Internet. The process of providing services comprises receiving requests sent from the clients, collecting client intelligence and feeding back information, etc. In essence, the server acts as an information provider of a computer network. The server generally is positioned at a service provider, or the service provider is configured to serve a content. Such a service provider may be, for example, a website of an Internet service provider.

Exemplary description of application scenarios of the related method and terminal of the present invention is made taking an example where an Android mobile terminal is the client and a cloud server is the server. A large number of target pictures including feature information such as road information, a direction of travel, photographing time and classification information are prestored in the server. The target pictures including one or more kinds of feature information can be precisely searched out using search keywords based on the above feature information. However, it should be noted that the description is merely exemplary, and the scope of the present invention is not limited thereto. The method and the terminal in the embodiments of the present invention may also be applicable to mobile terminals of other operating systems, which are essentially independent of the operating systems.

Specific embodiments of a plurality of technical solutions of the present invention proposed for implementing the above scenarios by using the above principles will be described in detail below. It is to be noted that a method for searching an on-the-way target picture provided by the present invention is first described from the viewpoint of a server, and the method for searching an on-the-way target picture may be implemented, by programming, as a computer program implemented on a remote network device, including but not limited to computers, network hosts, a single network server, a plurality of network server sets, or cloud composed of a plurality of servers.

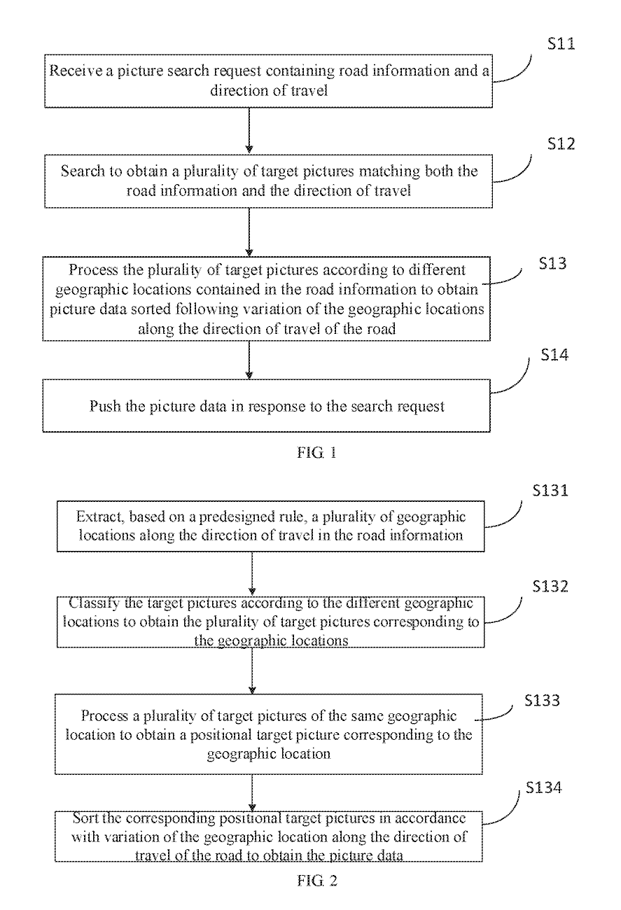

Referring to FIG. 1, a method for searching an on-the-way target picture according to a typical embodiment of the present invention specifically comprises following steps:

S11: receiving a picture search request including road information and a direction of travel.

After the server receives the picture search request sent from the mobile terminal, in response to the request, a webpage onto which target picture screening feature information may be inputted is returned to the mobile terminal, and the target picture screening information inputted onto the webpage by the mobile terminal is received. In an embodiment of the present invention, the screening information is road information and a direction of travel. For example, the received road information sent by the mobile terminal is “Sherman Load, Nanshan District, Shenzhen City”, the direction of travel is “from west to east”. In another embodiment of the present invention, the screening information may be road information, a direction of travel, and time information, wherein the time information may be specific moment information such as “21:30”, and the time information may also be time range information such as “from 12:00 to 13:00”. It is to be noted that the reason why the direction of travel is limited is that along two different directions of travel (prograde motion and retrograde motion) of a road, different sceneries corresponding to a prograde direction are viewed along the two directions of travel. Limiting the direction of travel is not only to implement accurate search and classification of pictures, but also to achieve a more real browsing effect of on-the-way sceneries, and enrich visual perception of the user.

In still another embodiment of the present invention, the screening information may further comprise picture classification information, wherein the picture classification information comprises one of a scenery, a figure and a road condition or any combination thereof. Of course, the premise resides in that the server stores a large number of target pictures including feature information such as road information, a direction of travel, photographing time, and classification information. Therefore, before the server receives a picture search request including road information and a direction of travel, the method further comprises following steps.

S111: in response to an image uploading request, receiving the target pictures and corresponding feature information thereof and storing the same into a picture database.

In response to the uploading request, the server receives any target picture uploaded by an authorized user registered to the server. The target picture carries feature information such as picture photographing time information, picture photographing geographic longitude and latitude information, a direction of travel, and picture classification information or the like. The picture photographing geographic longitude and latitude information and information of the direction of travel are extracted from GPS information of a mobile device of the target picture. The direction of travel is extracted from ground course information of the GPS information. That is, the road information of the target picture is stored in the form of geographic longitude and latitude information, and the direction of travel is stored in the form of ground course information. For example, the ground course information in the GPS information data is “course of 267°”, namely, turning 267° anticlockwise starting from the north, representing that the direction of travel of a device photographing the target picture is 87° south by west. That is, the photographed picture is on-the-way scenery corresponding to a prograde direction along the direction of travel of 87° south by west on the road.

The server receives the target picture and stores the target picture in the picture database, and also stores feature information corresponding to the target picture, Two embodiments where the server stores the target picture feature information are introduced below

1. In an embodiment of the present invention, the picture feature information may be read from a file attribute parameter of the target picture, for example, photographing time and GPS information (geographic longitude and latitude and a direction of travel). For example, for the target picture having a jpg or jpeg format, a file Exif attribute thereof comprises a tag User Comments serving as reservation. The tag may be user-defined added content. The feature information of the target picture may be stored into the Exif attribute of the picture by using the tag. Similarly, for a picture having other formats, for example, a target picture having a bmp or png format (no example is given herein), the feature information thereof may also be stored in attached information of the picture.

2. In another embodiment of the present invention, the picture feature information may be uploaded as additional user-defined data structure of the picture onto the server, and stored into a data table of the server. The data table and the target picture are associatively stored into a database of the server.

This storage mode is simple and feasible, and has better extendibility and maintainability. Those skilled in the art should know that the database mentioned here may be connected, as an individual device, to the server, or may serve as a constituent part of the server, for example, a database implemented by software in the server. A large amount of information can be stored using the storage mode of the data table without limiting the size of the feature information content of the target picture.

Further, to prevent the server from saving too many duplicate pictures, when the server receives a picture including picture feature information and stores the target picture into the picture database, the picture is stored into the database using an extracted MD5 value of the picture as a picture name. Because different pictures have different MD5 values, using the MD5 values of the pictures as the picture file names can prevent the server from storing too many duplicate pictures and thus increasing the burden of the server in storing and searching pictures. Therefore, limited storage space is saved, and the picture search efficiency is improved.

S112: extracting the feature information of the target pictures and establishing an index database including a mapping relation between the feature information and a URL address where the pictures are stored, wherein the feature information comprises geographic longitude and latitude, photographing time, direction of travel and picture classification information.

In the preceding Step S111 of saving, by the server, the target picture feature information according to two embodiments, a URL link address where the pictures are stored may be saved, and an index database including a mapping relation between the feature information and the URL address where the pictures are stored may be established. The feature information of the target picture comprises multiple feature information such as geographic longitude and latitude, photographing time, direction of travel and picture classification information. For the convenience of a retrieval request based on a certain type of or any multiple feature information, in an embodiment of the present invention, the index database comprises a plurality of index tables. Each of the index tables comprises at least one type of feature information and a URL address where the target picture including the feature information are stored. Index information is stored in the form of table to facilitate classified storage, and more plentiful information storage may be freely developed according to the user's demands.

Further, the method according to the present invention also comprises Step S12: searching to obtain a plurality of target pictures matching both the road information and the direction of travel.

Those skilled in the art should understand that a search engine may be invoked to implement a search operation. The search engine may be preferably implemented by a website independent device, or of cause, may be integrated into the server of the present invention. Such a deployment may depend on a scale of the server and a difference between an implemented function and a requirement. Of cause, other feasible forms may be adopted.

After a search request including road information and a direction of travel is received at the server, the received road information and the direction of travel are resolved. Specifically, in an embodiment of the present invention, a prestored electronic map may be invoked to search out a longitude-latitude range of the road information in the electronic map and a ground course angle along the direction of travel of the road. Based on the resolved longitude-latitude range and the ground course angle, a URL address of a target picture within the longitude-latitude range is searched out from an index table storing a mapping relation between the geographic longitude and latitude and the URL address of the target picture, and then an index table storing a mapping relation between the URL address and the ground course angle is searched in accordance with the URL address to obtain the ground course angle of the target picture. When the searched ground course angle is consistent with the ground course angle in the resolved search request, the corresponding URL address and the geographic longitude and latitude information thereof are stored into a newly established table. Corresponding feature information of the target pictures corresponding to all the URL addresses in the table matches the screening information in the search request.

It will be understood that the search request received by the server may further comprise moment information and time range information. Likewise, in an embodiment of the present invention, when the time information in the search request is the moment information, after the URL address of a target picture matching road information and a direction of travel is searched out, an index table storing the URL address and photographing time information is searched out based on the URL address to find the URL address corresponding to the target picture matching the moment information, and the corresponding URL address and the geographic longitude and latitude information are stored into a newly established table. Further, when the target picture matching the moment information cannot be obtained through searching, a plurality of moments comprised in particular time ranges prior to and posterior to the moment information are determined as moment information for searching.

Correspondingly, when the time information in the search request is the time range information, the URL address corresponding to the target picture, of which the photographing time information is within the range of the time range information is searched out, and the corresponding URL address and the geographic longitude and latitude information thereof are stored into a newly established table.

Further, in an embodiment of the present invention, the picture search request further comprises picture classification information, wherein the classification information comprises one of a scenery, a figure and a road condition and any combination thereof. Likewise, in an embodiment of the present invention, by searching out an index table associatively storing a URL address of a target picture and corresponding classification information thereof, the URL address of the target picture matching a search condition may be searched out, and a table including a mapping relation between the URL address and geographic longitude and latitude information of the corresponding target picture may be established.

In conclusion, in the above steps, based on a received picture search request including picture feature information, the search engine is driven to obtain a URL address where a plurality of target pictures are stored matching the feature information, and a table including a mapping relation between the URL address and geographic longitude and latitude information of the corresponding target picture is established.

Referring to FIG. 1, the method of the present invention further comprises Step S13: processing the plurality of target pictures according to different geographic locations included in the road information to obtain picture data sorted according to variation of the geographic locations along the direction of travel of the road. Specifically, referring to FIG. 2, this step further comprises following steps:

S131: extracting, based on a predesigned rule, a plurality of geographic locations along the direction of travel in the road information.

Specifically, in an embodiment of the present invention, the electronic map of the preset server is invoked to acquire a traveling path along the direction of travel of the road designated by the road information. Obviously, when a geographic region range included in the road information is larger, a geographic location on the road may be set, in the search request, as a starting point and/or a terminal point. Next, information of a plurality of geographic longitudes and latitudes at fixed interval is obtained along the movement locus based on a preset longitude-latitude distance, wherein the preset longitude-latitude distance is calculated based on longitudes and latitudes of two points. The plurality of geographic longitudes and latitudes are determined as a plurality of extracted geographic locations. For example, in an exemplary embodiment of the present invention, the road information comprised in the search request is “Sherman Load, Nanshan District, Shenzhen City”, the set geographic location of the starting point is “Hi-Tech Park”, the position of the terminal point is “Qiaocheng East”, geographic locations obtained by extracting, based on a certain specification, a movement locus along the direction of travel “from west to east” sequentially are Hi-Tech Park (113.960538, 22.546122), International Mayors Communication Centre (113.973348, 22.544937), Window of the World (113.980597, 22.543051), Overseas Chinese Town (113.991377, 22.539713), and Qiaocheng East (114.003883, 22.538611).

S132: classifying the target pictures according to the different geographic locations to obtain the plurality of target pictures corresponding to the geographic locations.

After extracting, based on a preset rule, a plurality of geographic locations in the road information along the direction of travel, in an embodiment of the present invention, by using a table, established in Step S12, including a mapping relation between a URL address where pictures are stored and geographic longitude and latitude information of a corresponding target picture, the geographic longitude and latitude information stored in the table is classified using a certain geographic clustering algorithm. That is, by taking a certain geographic location as a center, a plurality of target pictures corresponding to the geographic longitude and latitude information the nearest to the geographic location are classified into one type to obtain the plurality of target pictures of the geographic location.

S133: processing a plurality of target pictures of the same geographic location to obtain a positional target picture corresponding to the geographic location.

In this step, when the server processes a plurality of target pictures of the same geographic location, the plurality of target pictures are deduplicated and spliced to obtain a positional target picture corresponding to the geographic location. Specifically, the plurality of target pictures are deduplicated and spliced to obtain a panoramic picture corresponding to the geographic location. A plurality of pictures where the same geographic location comprises a part of identical picture content are deduplicated and spliced to obtain a panoramic picture, and the panoramic picture is stored into the database. In an embodiment of the present invention, content feature information of a plurality of target pictures of the same geographic location is matched, then a plurality of pictures having an overlapping region are mapped to the same coordinate system, and the plurality of target pictures are fused and spliced into a panoramic picture through a certain image fusion algorithm and the panoramic picture is stored in the database, wherein the image fusion algorithm may be an image fusion algorithm stored in the prior art or an image fusion algorithm improved on the basis of an existing fusion algorithm, for example, a common direct average method, a weighted average method, a Gaussian fusion method, and so on. However, this embodiment is not limited thereto. Finally, the URL address where the panoramic picture is stored and the geographic longitude and latitude information corresponding to the geographic location thereof are associatively stored into a newly established table.

A plurality of target pictures of the same geographic location are processed to obtain a positional target picture corresponding to the geographic location. More useful picture information is displayed within limited space and time when pictures are browsed in a mobile terminal. In this way, redundancy of information of a plurality of pictures comprising the same contents of the same geographic location is reduced for a user, the efficiency of browsing the plurality of pictures is improved for the user, and an ideal target picture browsing effect is achieved.

S134: sorting the corresponding positional target pictures in accordance with variation of the geographic location along the direction of travel of the road to obtain the picture data.

After the URI: address where the panoramic picture obtained by processing is stored and the corresponding geographic longitude and latitude information thereof are associatively stored into a newly established table in the above Step S133, in this step, the URL addresses of the panoramic pictures are sorted and stored based on a certain sort algorithm in accordance with sequential variation of the geographic longitude and latitude information along the direction of travel of the road.

Further, referring to FIG. 1, the method of the present invention further comprises Step S14: pushing the picture data in response to the search request.

This is to facilitate the user to continuously browse pictures using the mobile terminal as the geographic location thereof changes, thereby achieving a more real browsing effect of on-the-way sceneries. In an embodiment of the present invention, in response to the search request, the server pushes the picture data in the form of a video stream data packet.

Specifically, in an embodiment of the present invention, in response to the search request, the server pushes the picture data in the form of a video stream data packet. In an exemplary embodiment of the present invention, pictures are converted into video streaming using a third party open source library ffmpeg, which may support a variety of video formats and set a frame per second. First, a plurality of panoramic target picture tiles corresponding to a plurality of geographic locations processed and sorted in the above Step S13 are copied into a temporary directory to serve as each frame of picture of a video, and a natural number is taken as a file name to store each target picture. Supposing there are 1,001 pictures, these pictures are named, in sequence according to the order of the target pictures, as 0001.jpg, 0002.jpg, 0003.jpg . . . 1000.jpg, and 1001.jpg, and then a command ffmpeg -i/tmpdir/%04d.jpg is invoked to synthesize the pictures into video data, wherein the %04d.jpg indicates that the storage names of the pictures are 0001.jpg, 0002.jpg, 0003.jpg, and so on. Further, ffmpeg -r may be invoked to set a frame per second, and ffmpeg -vcodec may be invoked to designate an outputted video encoding format. After the target pictures are converted into video data, the URL address where the server stores the video data is returned to the mobile terminal sending the request. It is to be noted that this embodiment is merely exemplary, those skilled in the art also may adopt other technical means to implement this step, and an implementation of this embodiment does not constitute a limitation to the present invention.

The present invention further provides a method for searching an on-the-way target picture used in a mobile terminal, which is a method for searching an on-the-way target picture from the viewpoint of the mobile terminal. Likewise, the method for searching an on-the-way target picture may be implemented as a computer program by programming to run in a mobile phone, a tablet personal computer, and other mobile terminals having similar functions. For ease of understanding implementation of the method, in the present invention, an exemplary description of the implementation of the method is made taking an Android mobile phone as the mobile terminal. However, this does not constitute a limitation to the present invention.

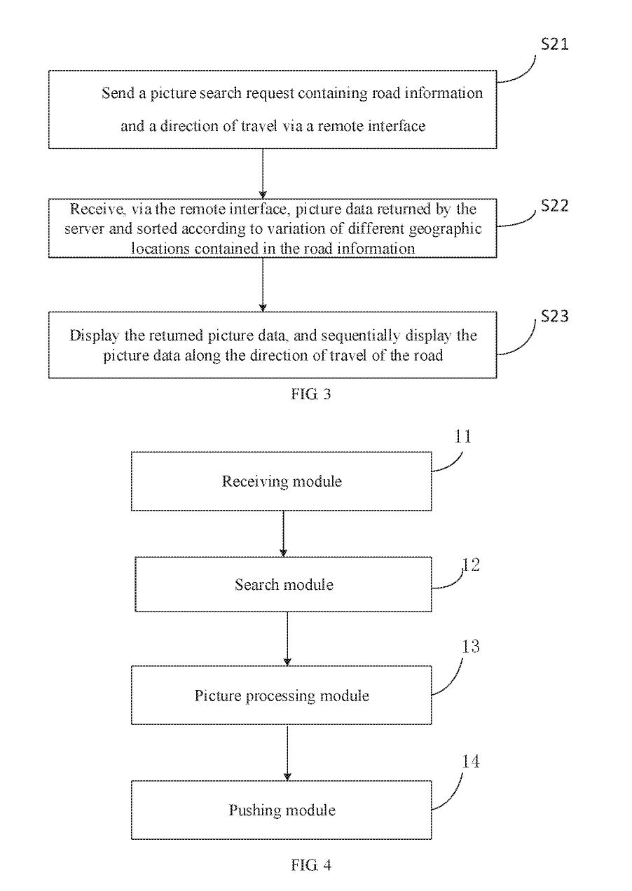

Referring to FIG. 3, a method for searching an on-the-way target picture used in a mobile terminal according to a typical embodiment of the present invention comprises the following step:

S21: sending a picture search request including road information and a direction of travel via a remote interface.

The mobile terminal sends an http search request to the server through the Internet. Those skilled in the art should leant that a network request in an Android mobile terminal generally uses Apache Http Client or HttpURLConnect to achieve network posting and getting requests, or also may use an android-async-http library, and use an android Handler message mechanism to transfer information. However, the present invention is not limited thereto. In an embodiment of the present invention, the mobile terminal packages data including a target picture search request into a JSON packet and then sends the packet to the server through the Internet. This technique may be implemented using an object and a method in JavaScript.

In an embodiment of the present invention, the feature information included in the picture search request is road information and a direction of travel. For example, the road information sent by the mobile terminal is “Sherman Load, Nanshan District, Shenzhen City”, the direction of travel is “from west to east”. In another embodiment of the present invention, the feature information may be road information, a direction of travel, and time information, wherein the time information may be specific moment information such as “21:30”, and the time information may also be time range information such as “from 12:00 to 13:00”. It is to be noted that the reason why the direction of travel is limited is that along two different directions of travel (prograde motion and retrograde motion) of a road, different sceneries corresponding to a prograde direction are viewed along the two directions of travel. Limiting the direction of travel is not only to implement accurate search and classification of pictures, but also to achieve a more real browsing effect of on-the-way sceneries, and enrich visual perception of the user.

In still another embodiment of the present invention, the screening information may further comprise picture classification information, wherein the picture classification information comprises one of a scenery, a figure and a road condition or any combination thereof Of course, the server prestores a large number of target pictures carrying feature information such as road information, a direction of travel, photographing time and classification information, etc.

Further, the road information and the direction of travel sent by the mobile terminal are acquired by extracting keywords from the inputted text search instruction; or the road information and the direction of travel are extracted from the GPS information of the mobile terminal; wherein the road information is the road region in which the region between a preset first distance and a preset second distance is located, and the first distance and the second distance are calculated with respect to the current GPS geographic location along the moving direction of the terminal and in front of the current GPS geographic location.

In an embodiment of the present invention, the Android mobile terminal obtains the road information and the direction of travel via a local GPS module. Specifically, the application scenario of this implementation is that in a process of travel, the user wants to know, in advance, on-the-way sceneries of a certain distance in front along the direction of travel. The Android mobile terminal invokes the local GPS module to obtain at least one piece of geographic longitude and latitude information and moving ground course information, acquires, in background at a certain time interval, geographic longitude and latitude information and course information in the GPS by way of a bound GPSCollectedService class, then sends the geographic longitude and latitude information and the course information to the server via the remote interface, and uploads the first distance and the second distance preset by the mobile terminal to the server. The server invokes the electronic map to analyze which road are the geographic longitude and latitude on, obtains the direction of travel along the road via ground course information, and analyzes information of the road region where a region between the first distance and the second distance preset in front is positioned on the basis of the obtained geographic longitude and latitude information. The distance is calculated based on longitudes and latitudes of two points, and the information of the road region is the feature information of the searched target picture.

Further, the method also comprises Step S22: receiving, via the remote interface, picture data returned by the server and sorted according to variation of different geographic locations included in the road information

After the mobile terminal sends the search request to the server through the Internet, the server resolves the received request, queries the database according to the query conditions provided by the user, sorts the obtained target pictures according to variation of different geographic locations included in the road information along the direction of travel to obtain picture data, and stores the picture data. A storage webpage address where the picture data are stored is returned to the mobile terminal via the remote interface, wherein the storage webpage address where the picture data are stored may be returned to the mobile terminal in the form of an XML file format or JSON data format. For example, in an embodiment of the present invention, the picture data received by the mobile terminal via the remote interface is in the format of JSONArray. The mobile terminal resolves the obtained JSON data to obtain identification information such as the stored URL address, the data format, the file name of the picture data, and so on.

Further, the method further comprises Step S23: displaying the returned picture data, wherein the picture data are sequentially displayed along the direction of travel of the road.

This is to facilitate the user to continuously browse pictures using the mobile terminal as the geographic location changes, thereby achieving a more real browsing effect of on-the-way sceneries. In an embodiment of the present invention, in response to the search request, the server returns the picture data in the form of a video stream data packet.

In the foregoing Step S22, the mobile terminal receives, via the remote interface, the storage URL address of the picture data returned by the server. Further, by loading the storage webpage address of the picture data returned by the server, the returned picture data are displayed in a display window of the webpage obtained by loading; or the picture data are downloaded via the storage webpage address and then are locally played. Embodiments of two different playback modes are introduced below.

1. In an embodiment of the present invention, network video data are played back by loading the storage webpage address of the video data. Specifically, the Android mobile terminal may use VideoView or Mediaplaver to play back video files, and may also invoke a video playback module by sending an Intent. For example, in an embodiment, setVideoURI(Uri uri) in VideoView is invoked to load a video corresponding to uri. The user performs user-defined regulation of a video playback speed via a speed regulation function of a network video player according to needs, such that the on-the-way target pictures sequentially displayed on the direction of travel of the road may be seen on the mobile terminal.

2. In another embodiment of the present invention, a video downloading page is loaded via Loadurl in Webview of Android, video data are downloaded locally and ffmpeg is invoked to decode the video data, and a video file with a certain particular format obtained by decoding is stored into a local storage medium. Next, a locally independent third party video playback software may be employed to play back the video data, and a playback speed setting function of the video playback software may be employed to regulate the video playback speed. The video playback module may also be invoked by sending an Intent. For example, a storage path of a video file is sdcard, a storage name and format is test.mp4, locally stored video data are loaded via Uri uri=Uri.parse(“file:///sdcard/testmp4”), and intent.setDataAndType( ) and startActivity(intent) are invoked to play back the locally stored video data, such that the on-the-way target pictures sequentially displayed on the direction of travel of the road may be seen on the mobile terminal.

In conclusion, in the present invention, a user sends, via a remote interface of the mobile terminal, a picture search request including road information and a direction of travel to a server. The server processes the plurality of target pictures matching the road information and the direction of travel according to different geographic locations included in the road information to obtain picture data sorted according to variation of the geographic locations along the direction of travel of the road. The mobile terminal displays the picture data pushed by the server. That is, the picture data are sequentially displayed along the direction of travel of the road. After a plurality of pictures along a certain direction of travel of a certain road are screened and sorted by a server, data of a plurality of target pictures sequentially changing along the direction of travel of the road can be efficiently browsed on the mobile terminal. In this way, continuity of picture browsing in variation of the geographic locations is implemented, a more real browsing effect of on-the-way sceneries is achieved, and visual perception of the user is enriched.

Further, in accordance with a function modularization thinking of a computer software, the present invention further provides a server in which the method for searching an on-the-way target picture is used, referring to FIG. 4. The server comprises a receiving module 11, a search module 12, a picture processing module 13, and a pushing module 14. A principle framework of the server is constructed using the receiving module 11, the search module 12, the picture processing module 13, and the pushing module 14. In this way, a modular implementation solution is implemented. Specific functions of each module is specifically revealed as below.

The receiving module 11 is configured to receive a picture search request including road information and a direction of travel.

After the receiving module 11 of the server receives the picture search request sent from the mobile terminal, in response to the request, a webpage onto which target picture screening feature information may be inputted is returned to the mobile terminal, and the target picture screening information inputted onto the webpage by the mobile terminal is received. In an embodiment of the present invention, the screening information is road information and a direction of travel. For example, the road information sent by the mobile terminal and received by the receiving module 11 is “Sherman Load, Nanshan District, Shenzhen City”, the direction of travel is “from west to east”. In another embodiment of the present invention, the screening information received by the receiving module 11 may be road information, a direction of travel, and time information, wherein the time information may be specific moment information such as “21:30”, and the time information may also be time range information such as “from 12:00 to 13:00”. It is to be noted that the reason why the direction of travel is limited is that along two different directions of travel (prograde motion and retrograde motion) of a road, different sceneries corresponding to a prograde direction are viewed along the two directions of travel. Limiting the direction of travel is not only to implement accurate search and classification of pictures, but also to achieve a more real browsing effect of on-the-way sceneries, and enrich visual perception of the user.

In still another embodiment of the present invention, the screening information received by the receiving module 11 may further comprise picture classification information, wherein the picture classification information comprises one of a scenery, a figure and a road condition or any combination thereof. Of course, the premise resides in that the server stores a large number of target pictures including feature information such as road information, direction of travel, photographing time, and classification information. Therefore, before the receiving module 11 receives the picture search request including road information and a direction of travel, it is still required to invoke a storage module of the server to prestore the target picture carrying the above feature information.

Specifically, in response to an image uploading request, the storage module receives the target pictures and corresponding feature information thereof and stores the same into a picture database.

In response to the uploading request, the storage module of the server receives any target picture uploaded by an authorized user registered to the server. The target picture carries feature information such as picture photographing time information, picture photographing geographic longitude and latitude information, a direction of travel, and picture classification information or the like. The picture photographing geographic longitude and latitude information and information of the direction of travel are extracted from GPS information of a mobile device of the target picture. The direction of travel is extracted from ground course information of the GPS information. That is, the road information of the target picture is stored in the form of geographic longitude and latitude information, and the direction of travel is stored in the form of ground course information. For example, the ground course information in the GPS information data is “course of 267°”, namely, turning 267° anticlockwise starting from the north, representing that the direction of travel of a device photographing the target picture is 87° south by west. That is, the photographed picture is on-the-way scenery corresponding to a prograde direction along the direction of travel of 87° south by west.

The storage module of the server receives the target picture and stores the target picture in the picture database, and also stores feature information corresponding to the target picture. Two embodiments where the server storage module stores the target picture feature information are introduced below.

1. In an embodiment of the present invention, the picture feature information may be read from a file attribute parameter of the target picture, for example, photographing time and GPS information (geographic longitude and latitude and direction of travel). For example, for the target picture having a jpg or jpeg format, a file Exif attribute thereof comprises a tag User Comments serving as reservation. The tag may be user-defined added content. The feature information of the target picture may be stored into the Exif attribute of the picture by using the tag. Similarly, for a picture having other formats, for example, a target picture having a bmp or png format (no example is given herein), the feature information thereof may also be stored in attached information of the picture.

2. In still another embodiment of the present invention, the picture feature information may be uploaded as additional user-defined data structure of the picture onto the server storage module, and stored into a data table of the server. The data table and the target picture are associatively stored into a database of the server. This storage mode is simple and feasible, and has better extendibility and maintainability. Those skilled in the art should know that the database mentioned here may be connected, as an individual device, to the server, or may serve as a constituent part of the server, for example, a database implemented by software in the server. A large amount of information can be stored using the storage mode of the data table without limiting the size of the feature information content of the target picture.

Further, to prevent the server from saving too many duplicate pictures, when the server receives a picture including picture feature information and stores the picture into the picture database, the picture is stored into the database using an extracted MD5 value of the picture as a picture name. Because different pictures have different MD5 values, using the MD5 values of the pictures as the file names of pictures can prevent the server from storing too many duplicate pictures and thus increasing the burden of the server in storing and searching pictures. Therefore, limited storage space is saved, and the picture search efficiency is improved.

Further, the server storage module is also configured to extract the feature information of the target pictures and establish an index database including a mapping relation between the feature information and a URL address where the pictures are stored, wherein the feature information comprises geographic longitude and latitude, photographing time, direction of travel and picture classification information.

When saving the target picture feature information, the server storage module also may save a URL link address where the pictures are stored, and establish an index database including a mapping relation between the feature information and the URL address where the pictures are stored. The feature information of the target picture comprises multiple feature information such as geographic longitude and latitude, photographing time, direction of travel and picture classification information. For the convenience of a retrieval request based on a certain type of or any multiple feature information, in an embodiment of the present invention, the index database comprises a plurality of index tables. Each of the index tables comprises at least one type of feature information and a URL address where the target pictures including the feature information are stored. Index information is stored in the form of table to facilitate classified storage, and more plentiful information storage may be freely developed according to the user's demands.

Further, the search module 12 is configured to search to obtain a plurality of target pictures matching both the road information and the direction of travel. Specifically, the search module 12 further comprises a query unit and an acquiring unit. The query unit is configured to query, based on the road information and the direction of travel, an index table comprising a mapping relation between the feature information and a URL address of a picture to obtain the URL address of the target picture. The acquiring unit is configured to respectively acquire a plurality of target pictures in accordance with the URL address of the target picture.

Those skilled in the art shall understand that the search module 12 may be a search engine. The search engine may be preferably implemented by a website independent device, or of cause, may be integrated into the server of the present invention. Such a deployment may depend on a scale of the server and a difference between an implemented function and a requirement. Of cause, other feasible forms may be also adopted.

After the server receiving module 11 receives a search request including road information and a direction of travel, the query unit resolves the received road information and the direction of travel. Specifically, in an embodiment of the present invention, the query unit may invoke a prestored electronic map to search out a longitude-latitude range of the road information in the electronic map and a ground course angle along the direction of travel of the road. Based on the resolved longitude-latitude range and the ground course angle, the query unit searches out, from the index table storing a mapping relation between the geographic longitude and latitude and a URL address of a target picture, the URL address of the target picture within the longitude-latitude range, and then searches from an index table storing a mapping relation between the URL address and the ground course angle in accordance with the URL address to obtain the ground course angle of the target picture. When the ground course angle searched by the query unit is consistent with the ground course angle in the resolved search request, the corresponding URL address and the geographic longitude and latitude information thereof are stored into a newly established table. Corresponding feature information of the target pictures corresponding to all the URL addresses in the table matches the screening information in the search request. Next, the acquiring unit is invoked to respectively acquire a plurality of target pictures in accordance with the URL address of the target picture.

It is to be understood that the search request received by the receiving module 11 of the server may further comprise moment information and time range information. Likewise, in an embodiment of the present invention, when the time information in the search request is the moment information, after searching out the URL address of a target picture matching the road information and the direction of travel, the query unit searches out an index table storing the URL address and photographing time information based on the URL address to find the URL address corresponding to the target picture matching the moment information, stores the corresponding URL address and the geographic longitude and latitude information thereof into a newly established table, and then invokes the acquiring unit to respectively acquire a plurality of target pictures in accordance with the URL address of the target picture. Further, when the query unit cannot obtain, through searching, the target picture matching the moment information, the query unit determines a plurality of moments comprised in particular time ranges prior to and posterior to the moment information as moment information for searching.

Correspondingly, when the time information in the search request is the time range information, the search module 12 searches out the URL address corresponding to the target picture, of which the photographing time information is within the range of the time range information in the search request, stores the corresponding URL address and the geographic longitude and latitude information thereof into a newly established table, and then invokes the acquiring unit to respectively acquire a plurality of target pictures in accordance with the URL address of the target picture.

Further, in an embodiment of the present invention, the picture search request further comprises picture classification information, wherein the classification information comprises one of a scenery, a figure and a road condition and any combination thereof. Likewise, in an embodiment of the present invention, by searching, via the query unit, out an index table associatively storing a URL address of a target picture and corresponding classification information thereof, the URL address of the target picture matching a search condition may be searched out, and a table including a mapping relation between the URL address and geographic longitude and latitude information of the corresponding target picture may be established. Next, the acquiring unit is invoked to respectively acquire a plurality of target pictures in accordance with the URL address of the target picture.

In conclusion, based on a picture search request including picture feature information received by the receiving module 11, the search module 12 searches to obtain a URL address, where a plurality of target pictures are stored, matching the feature information, and establishes a table including a mapping relation between the URL address and geographic longitude and latitude information of the corresponding target picture.

Referring to FIG. 4, the picture processing module 13 of the present invention is configured to process the plurality of target pictures according to different geographic locations included in the road information to obtain picture data sorted according to variation of the geographic locations along the direction of travel of the road. Specifically, referring to FIG. 5, the picture processing module 13 further comprises an extracting unit 131, a classifying unit 132, a processing unit 133, and a sorting unit 134.

The extracting unit 131 is configured to extract, based on a predesigned rule, a plurality of geographic locations along the direction of travel in the road information.

Specifically, in an embodiment of the present invention, the extracting unit 131 invokes an electronic map of the preset server to acquire a traveling path along the direction of travel of the road designated by the road information. Of course, when a geographic region range included in the road information is larger, a geographic location on the road may be set, in the search request, as a starting point and/or a terminal point. Next, the extracting unit 131 obtains information of a plurality of geographic longitudes and latitudes at fixed interval along the movement locus based on a preset longitude-latitude distance, wherein the preset longitude-latitude distance is calculated based on longitudes and latitudes of two points. The plurality of geographic longitudes and latitudes are determined as a plurality of extracted geographic locations. For example, in an exemplary embodiment of the present invention, the road information comprised in the search request is “Sherman Load, Nanshan District, Shenzhen City”, the set geographic location of the starting point is “Hi-Tech Park”, the position of the terminal point is “Qiaocheng East”, geographic locations in the road obtained by extracting by the extracting unit 131, based on a certain specification, along the direction of travel “from west to east” sequentially are Hi-Tech Park (113.960538, 22.546122), International Mayors Communication Centre (113.973348, 22.544937), Window of the World (113.980597, 22.543051), Overseas Chinese Town (113.991377, 22.539713), and Qiaocheng East (114.003883, 22.538611).

The classifying unit 132 is configured to classify the target pictures according to the different geographic locations to obtain the plurality of target pictures corresponding to the geographic locations.

After the extracting unit 131 extracts, based on a preset rule, a plurality of geographic locations along the direction of travel in the road information, in an embodiment of the present invention, by using a table, established by the search module 12, including a mapping relation between a URL address where pictures are stored and geographic longitude and latitude information of a corresponding target picture, the classifying unit 132 classifies the geographic longitude and latitude information stored in the table using a certain geographic clustering algorithm. That is, by taking a certain geographic location as a center, a plurality of target pictures corresponding to the geographic longitude and latitude information the nearest to the geographic location are classified into one type to obtain the plurality of target pictures of the geographic location.

The processing unit 134 is configured to process a plurality of target pictures of the same geographic location to obtain a positional target picture corresponding to the geographic location.

When the processing unit 134 processes a plurality of target pictures of the same geographic location, the plurality of target pictures are deduplicated and spliced to obtain a positional target picture corresponding to the geographic location. Specifically, the processing unit 134 deduplicates and splices the plurality of target pictures to obtain a panoramic picture corresponding to the geographic location, a plurality of pictures where the same geographic location comprises a part of identical picture content are deduplicated and spliced to obtain a panoramic picture, and the panoramic picture is stored into the database. In an embodiment of the present invention, the processing unit 134 matches content feature information of a plurality of target pictures of the same geographic location, then maps a plurality of pictures having an overlapping region to the same coordinate system, and fuses and splices the plurality of target pictures into a panoramic picture through a certain image fusion algorithm and stores the panoramic picture in the database, wherein the image fusion algorithm may be an image fusion algorithm stored in the prior art or an image fusion algorithm improved on the basis of an existing fusion algorithm, for example, a common direct average method, a weighted average method, a Gaussian fusion method, and so on. However, this embodiment is not limited thereto. Finally, the processing unit 134 associatively stores the URL address where the panoramic picture is stored and the geographic longitude and latitude information corresponding to the geographic location thereof into a newly established table.

The processing unit 134 processes a plurality of target pictures of the same geographic location to obtain a positional target picture corresponding to the geographic location. More useful picture information is displayed within limited space and time when pictures are browsed in a mobile terminal. In this way, redundancy of information of a plurality of pictures comprising the same contents of the same geographic location is reduced for a user, the efficiency of browsing the plurality of pictures is improved for the user, and an ideal target picture browsing effect is achieved.

The sorting unit 134 is configured to sort the corresponding positional target pictures in accordance with variation of the geographic location along the direction of travel of the road to obtain the picture data.

After the processing unit 133 associatively stores the URL address, obtained by processing, where the panoramic picture is stored and the corresponding geographic longitude and latitude information thereof into a newly established table, the sorting unit 134 sorts and stores URL addresses of the panoramic pictures based on a certain sort algorithm in accordance with sequential variation of the geographic longitude and latitude information along the direction of travel of the road.

Further, referring to FIG. 4, the server of the present invention also comprises a pushing module 14, configured to push the picture data in response to the search request.

This is to facilitate the user to continuously browse pictures using the mobile terminal as the geographic location changes, thereby achieving a more real browsing effect of on-the-way sceneries. In an embodiment of the present invention, in response to the search request, the pushing module 14 pushes the picture data in the form of a video stream data packet.

Specifically, in an embodiment of the present invention, in response to the search request, the pushing module 14 pushes the picture data in the form of a video stream data packet. In an exemplary embodiment of the present invention, pictures are converted into video streaming using a third party open source library ffmpeg, which may support a variety of video formats and set a frame per second. First, the pushing module 14 copies a plurality of panoramic target picture files corresponding to a plurality of geographic locations processed and sorted by the picture processing module 13 into a temporary directory to serve as each frame of picture of a video, and stores each target picture taking a natural number as a file name. Supposing there are 1,001 pictures, these pictures are named, in sequence according to the order of the target pictures, as 0001.jpg, 0002.jpg, 0003.jpg . . . 1000.jpg, and 1001.jpg, and then a command ffmpeg -i/tmpdir/%04d.jpg is invoked to synthesize the pictures into video data, wherein the %04d.jpg indicates that the storage names of the pictures are 0001.jpg, 0002.jpg, 0003.jpg, and so on. Further, ffmpeg -r may be invoked to set a frame per second, and ffmpeg -vcodec may be invoked to designate an outputted video encoding format. After the target pictures are converted into video data, the pushing module 14 returns the URL address where the server stores the video data to the mobile terminal sending the request. It is to be noted that this embodiment is merely exemplary, those skilled in the art also may adopt other technical means to implement this step, and an implementation of this embodiment does not constitute a limitation to the present invention.

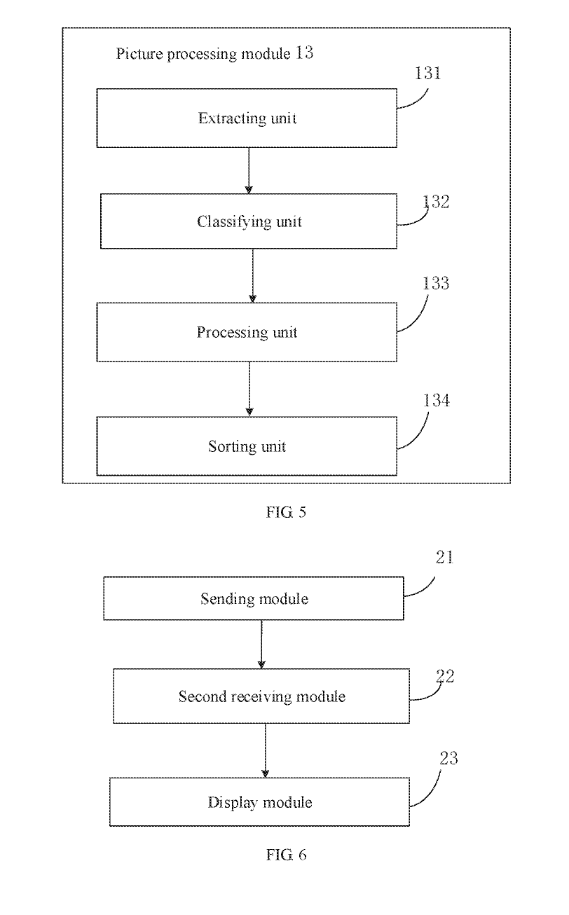

Similarly, in accordance with a function modularization thinking of a computer software, the present invention further provides a mobile terminal using the method for searching an on-the-way target picture, referring to FIG. 6. The mobile terminal comprises a sending module 21, a second receiving module 22, and a display module 23. A principle framework of the whole mobile terminal is constructed using the sending module 21, the second receiving module 22, and the display module 23. In this way, a modular implementation solution is implemented. Specific functions of each module is specifically revealed as below. For ease of understanding implementation of each module, in the present invention, an exemplary description of the implementation of each module is made taking an Android mobile phone as the mobile terminal. However, this does not constitute a limitation to the present invention.

The sending module 21 is configured to send a picture search request including road information and a direction of travel via a remote interface.

The sending module 21 of the mobile terminal sends an http search request to the server through the Internet. Those skilled in the art should learn that a network request in an Android mobile terminal generally uses Apache Http Client or HttpURLConnect to achieve network posting and getting requests, or also may use an android-async-http library, and use an android Handler message mechanism to transfer information. However, the present invention is not limited thereto. In an embodiment of the present invention, the sending module 21 packages data including a target picture search request into a JSON packet and then sends the packet to the server through the Internet. This technique may be implemented using an object and a method in JavaScript.

In an embodiment of the present invention, the feature information included in the picture search request sent by the sending module 21 is road information and a direction of travel. For example, the road information sent by the mobile terminal is “Sherman Load, Nanshan District, Shenzhen City”, the direction of travel is “from west to east”. In another embodiment of the present invention, the feature information sent by the sending module 21 may be road information, a direction of travel, and time information, wherein the time information may be specific moment information such as “21:30”, and the time information may also be time range information such as “from 12:00 to 13:00”. It is to be noted that the reason why the direction of travel is limited is that along two different directions of travel (prograde motion and retrograde motion) of a road, different sceneries corresponding to a prograde direction are viewed along the two directions of travel. Limiting the direction of travel is not only to implement accurate search and classification of pictures, but also to achieve a more real browsing effect of on-the-way sceneries, and enrich visual perception of the user.

In still another embodiment of the present invention, the search feature information sent by the sending module 21 may further comprise picture classification information, wherein the classification information comprises one of a scenery, a figure and a road condition or any combination thereof Of course, the server prestores a large number of target pictures carrying feature information such as road information, direction of travel, photographing time and classification information, etc.

Further, the road information and the direction of travel sent by the sending module 21 are obtained by extracting keywords from the inputted text search instruction; or the road information and the direction of travel are extracted from the GPS information of the mobile terminal; wherein the road information is the road region in which the region between a preset first distance and a preset second distance is located, and the first distance and the second distance are calculated with respect to the current GPS geographic location along the moving direction of the terminal and in front of the current GPS geographic location.

In an embodiment of the present invention, the sending module 21 of the Android mobile terminal obtains the road information and the direction of travel via a local GPS module. Specifically, the application scenario of this implementation is that in a process of travel, the user wants to know, in advance, on-the-way sceneries a certain distance in front along the direction of travel. The Android mobile terminal invokes the local GPS module to obtain at least one piece of geographic longitude and latitude information and moving ground course information, acquires, at a certain time interval, geographic longitude and latitude information and course information in the GPS by way of a hound GPSCollectedService class, then sends the geographic longitude and latitude information and the course information to the server via the remote interface, and uploads the first distance and the second distance preset by the mobile terminal to the server. The server invokes the electronic map to analyze which road are the geographic longitude and latitude on, obtains the direction of travel along the road via ground course information, and analyzes information of the road region where a region between the first distance and the second distance preset in front is positioned on the basis of the obtained geographic longitude and latitude information. The distance is calculated based on longitudes and latitudes of two points, and the information of the road region is the feature information of the searched target picture.

Further, the second receiving module 22 is configured to receive, via the remote interface, picture data returned by the server and sorted according to variation of different geographic locations included in the road information.

After the sending module 21 of the mobile terminal sends the search request to the server through the Internet, the server resolves the received request, queries the database according to the query conditions provided by the user, sorts the obtained target pictures according to variation of different geographic locations included in the road information along the direction of travel to obtain picture data, and stores the picture data. A storage webpage address where the picture data are stored is returned to the mobile terminal via the remote interface, wherein the storage webpage address where the picture data are stored may be returned to the mobile terminal in the form of an XML file format or JSON data format. For example, in an embodiment of the present invention, the picture data received by the second receiving module 22 via the remote interface is in the format of JSONArray. The mobile terminal resolves the obtained JSON data to obtain identification information such as the storage URL address, the data format, the file name of the picture data, and so on.

Further, the display module 23 is configured to display the returned picture data, wherein the picture data are sequentially displayed along the direction of travel of the road.

This is to facilitate the user to continuously browse pictures using the mobile terminal as the geographic location changes, thereby achieving a more real browsing effect of on-the-way sceneries. In an embodiment of the present invention, in response to the search request, the server returns the picture data in the form of a video stream data packet.

The second receiving module 22 of the mobile terminal receives, via the remote interface, the storage URL address where the picture data returned by the server are stored. Further, by loading the storage webpage address where the picture data returned by the server are stored, the returned picture data displayed by the display module 23 are displayed in a display window of the webpage obtained by loading; or the picture data are downloaded via the storage webpage address and then are locally played. Embodiments of two different playback modes are introduced below.

1. In an embodiment of the present invention, the display module 23 plays back network video data by loading the storage webpage address where the video data are stored. Specifically, the display module 23 of the Android mobile terminal may use VideoView or Mediaplayer to play back video files, and may also invoke a video playback module by sending an Intent. For example, in an embodiment, the display module 23 invokes setVideoURI(Uri uri) in VideoView to load a video corresponding to uri. The user performs user-defined regulation of a video playback speed via a speed regulation function of a network video player according to needs, such that the on-the-way target pictures sequentially displayed on the direction of travel of the road may be seen on the mobile terminal.

2. In another embodiment of the present invention, the display module 23 loads a video downloading page via Loadurl in Webview of Android, downloads video data locally and invokes ffmpeg to decode the video data, and stores a video file with a certain particular format obtained by decoding into a local storage medium. Next, the display module 23 may use a locally independent third party video playback software to play back the video data, and use a playback speed setting function of the video playback software to regulate the video playback speed. The display module 23 also may send an Intent to invoke the video playback module. For example, a storage path of a video file is sdcard, a storage name and format is test.mp4, locally stored video data are loaded via Uri uri=Uri.parse(“file:///sdcard/test.mp4”), and intent.setDataAndType( ) and startActivity(intent) are invoked to play back the locally stored video data, such that the on-the-way target pictures sequentially displayed on the direction of travel of the road may be seen on the mobile terminal.

In conclusion, in the present invention, a user sends, via a remote interface of the mobile terminal, a picture search request including road information and a direction of travel to a server. The server processes the plurality of target pictures matching the road information and the direction of travel according to different geographic locations included in the road information to obtain picture data sorted according to variation of the geographic locations along the direction of travel of the road. The mobile terminal displays the picture data pushed by the server. That is, the picture data are sequentially displayed along the direction of travel of the road. After a plurality of pictures along a certain direction of travel of a certain road are screened and sorted by a server, data of a plurality of target pictures sequentially changing along the direction of travel of the road can be efficiently browsed on the mobile terminal. In this way, continuity of picture browsing in variation of the geographic locations is implemented, a more real browsing effect of on-the-way sceneries is achieved, and visual perception of the user is enriched.

Further, referring to FIG. 7, for ease of understanding the implementation of the method for searching an on-the-way target picture as recited in the present invention, the present invention also provides a system for searching an on-the-way target picture. The system comprises a server 20 and a mobile terminal 10. The whole system using the method for searching an on-the-way target picture according to the present invention is introduced with reference to the server and the mobile terminal.

In the mobile terminal 10, when the user wants to browse target pictures along a certain road via the Internet, a picture search request including road information and a direction of travel is sent via a remote interface of the mobile terminal 10. The server 20 receives the search request, resolves the road information and the direction of travel included in the search request, and drives a search engine to search a database prestoring a large number of pictures and corresponding feature information thereof to obtain a plurality of target pictures matching the road information and the direction of travel included in the search request. Furthermore, the server 20 extracts a plurality of geographic locations along the direction of travel in the road information based on a predesigned rule, classifies the target pictures according to the different geographic locations to obtain the plurality of target pictures corresponding to the geographic locations, processes a plurality of target pictures of the same geographic location to obtain a positional target picture corresponding to the geographic location, and sorts the corresponding positional target pictures according to variation of the geographic location along the direction of travel of the road to obtain the picture data. Finally the server 20 pushes the picture data in response to the search request of the mobile terminal 10. The mobile terminal 10 displays the returned picture data, wherein the picture data are sequentially displayed along the direction of travel of the road in the form of video stream. Of course, in addition to the road information and the direction of travel, the search request sent by the mobile terminal 10 may further comprise time information and picture classification information, wherein the time information may be moment information and time range information, and the picture classification information may be any one of a scenery, a figure and a road condition or any combination thereof.

In an application scenario of the present invention, a mobile terminal implementing the technical solution of the present invention can access a server through the Internet. When a user wants to view on-the-way sceneries along a certain direction of travel of a certain road, for example, the user wants to view on-the-way sceneries along a prograde direction “from west to east” of “Sherman Load, Nanshan District, Shenzhen City”, after the user logs onto the server implementing the technical solution of the present invention, a search request including road information “Sherman Load, Nanshan District, Shenzhen City”, a direction of travel “from west to east” and classification information “scenery” to the server through the Internet. After receiving the search request, the server resolves the road information and the direction of travel included in the search request, and drives a search engine to search a database prestoring a large number of pictures and corresponding feature information thereof to obtain a plurality of scenery pictures matching the road information and the direction of travel included in the search request. Furthermore, the server invokes a preset electronic map to acquire a movement locus along the direction of travel from west to east of the road designated by the road information, and acquires a plurality of geographic locations on the traveling path by a certain longitude-latitude distance. For example, the obtained geographic locations sequentially are Hi-Tech Park (113.960538, 22.546122), International Mayors Communication Centre (113.973348, 22.544937), Window of the World (113.980597, 22.543051), Overseas Chinese Town (113.991377, 22.539713), and Qiaocheng East (114.003883, 22.538611). Next, the server classifies the target scenery pictures according to the different geographic locations to obtain the plurality of target pictures corresponding to the geographic locations, deduplicates and splices the plurality of target pictures in the same geographic location to obtain a panoramic target picture corresponding to the geographic location, and sorts the corresponding panoramic target pictures in accordance with variation of the geographic location along the direction of travel of the road to obtain the picture data. The picture data are converted into a video data package at the server before being pushed to the mobile terminal. The mobile terminal displays the picture data returned by the server. The picture data are sequentially displayed along the movement locus of the direction of travel of the road in the form of video stream. Therefore, even though a user stays at home, the user still can browse, on the server via the mobile terminal, on-the-way pictures sequentially displayed along the movement locus of a direction of travel of a certain road. In this way, continuity of picture browsing in variation of the geographic locations is effectively implemented, a more real browsing effect of on-the-way sceneries is achieved, and visual perception of the user is enriched.

Each of devices according to the embodiments of the present invention can be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the parts in the visualization graphic encoding processed by the mobile terminal according to the embodiments of the present invention. The present invention may further be implemented as equipment or device program (for example, computer program and computer program product) for executing some or all of the methods as described herein. Such program for implementing the present invention may be stored in the computer readable medium, or have a form of one or more signals. Such a signal may be downloaded from the Internet websites, or be provided on a carrier signal, or provided in any other form.

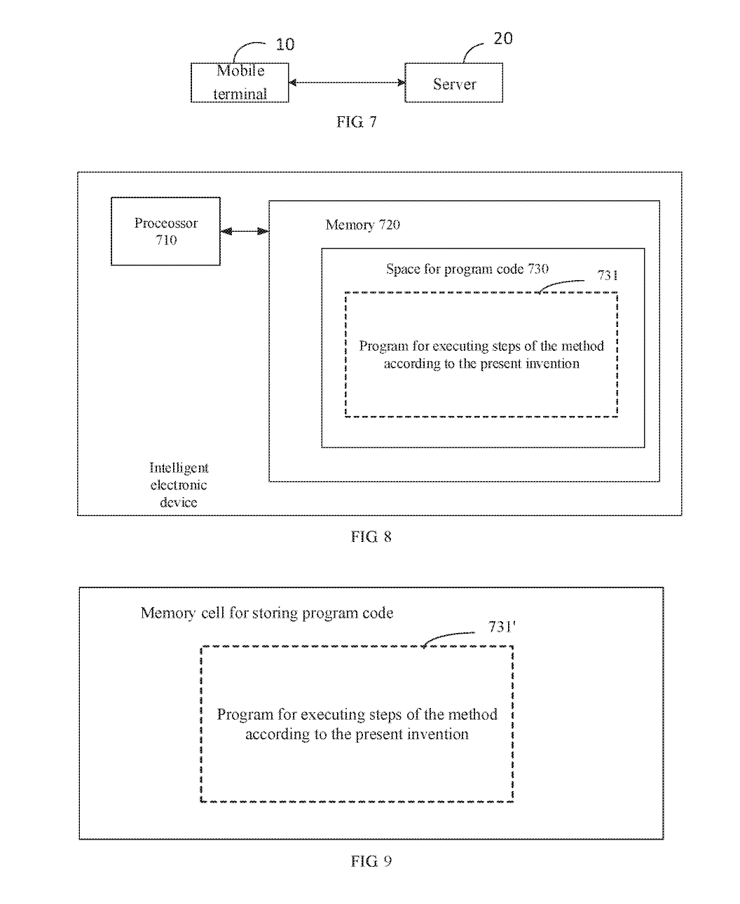

For example, FIG. 8 illustrates an intelligent electronic device that may implement a file encryption method according to the present invention. Traditionally, the intelligent electronic device comprises a processor 710 and a computer program product or a computer readable medium in form of a memory 720. The memory 720 may be electronic memories such as flash memory, EEPROM (Electrically Erasable Programmable Read-Only Memory), EPROM, hard disk or ROM. The memory 720 has a memory space 730 for executing program codes 731 of any steps in the above methods. For example, the memory space 730 for program codes may comprise respective program codes 731 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 9. The memory cells may be provided with memory sections, memory spaces, etc., similar to the memory 720 of the intelligent electronic device as shown in FIG. 8. The program codes may be compressed for example in an appropriate form. Usually, the memory cell comprises programs 731′ for performing the steps of the method according to the present invention, namely, codes which can be read for example by processors 710. When these codes are operated on the intelligent electronic device, the intelligent electronic device is caused to execute respective steps in the method as described above.

Many details are discussed in the specification provided herein. However, it should be understood that the embodiments of the present invention can be implemented without these specific details. In some embodiments, the well-known methods, structures and technologies are not shown in detail so as to avoid an unclear understanding of the description.

Although some exemplary embodiments of the present invention have been illustrated above, those skilled in the art will appreciate that changes may be made to these exemplary embodiments without departing from the principle or spirit of the present invention, and the scope of the present invention is limited by the claims and equivalents thereof

1. A method for searching an on-the-way target picture, comprising steps of:
receiving a picture search request, wherein the picture search request comprises road information and a direction of travel;
searching to obtain a plurality of target pictures matching the picture search request, wherein the target pictures match both the road information and the direction of travel;
processing the plurality of target pictures according to different geographic locations included in the road information to obtain picture data sorted according to variation of the geographic locations and matching the picture search request; and
pushing the picture data in response to the picture search request.

2. The method according to claim 1, wherein the picture search request further comprises moment information, and the step of searching to obtain a plurality of target pictures matching the picture search request comprises:
searching to obtain a plurality of target pictures matching the moment information, the road information and the direction of travel.

3. The method according to claim 1, wherein the picture search request further comprises time range information, and the step of searching to obtain a plurality of target pictures matching the picture search request comprises:
searching to obtain a plurality of target pictures matching the time range information, the road information and the direction of travel.

4. The method according to claim 1, wherein before the step of receiving the picture search request including the road information and the direction of travel, the method further comprises:
in response to an image uploading request, receiving the target pictures and corresponding feature information thereof and storing into a picture database; and
extracting the feature information of the target pictures and establishing an index database including a mapping relation between the feature information and a URL address where the pictures are stored, wherein the feature information comprises geographic longitude and latitude, photographing time, direction of travel and picture classification information.

5. The method according to claim 2, wherein when the target picture matching the moment information is unable to be obtained through searching, determining a plurality of moments comprised in particular time ranges prior to and posterior to the moment information as moment information for searching.

6. The method according to claim 4, wherein the step of searching to obtain a plurality of target pictures matching the picture search request comprises:
querying, based on the road information and the direction of travel, an index table comprising a mapping relation between the feature information and a URL address of a picture to obtain the URL address of the target picture; and
respectively obtaining a plurality of target pictures in accordance with the URL address of the target picture.

7. The method according to claim 1, wherein the step of processing the plurality of target pictures according to different geographic locations included in the road information to obtain picture data sorted according to variation of the geographic locations and matching the picture search request specifically comprises:
extracting, based on a predesigned rule, a plurality of geographic locations along the direction of travel in the road information;
classifying the target pictures according to the different geographic locations to obtain the plurality of target pictures corresponding to the geographic locations;
processing a plurality of target pictures of the same geographic location to obtain a positional target picture corresponding to the geographic location; and
sorting the corresponding positional target pictures in accordance with variation of the geographic location along the direction of travel of the road to obtain the picture data.

8. The method according to claim 7, wherein the step of extracting, based on a predesigned rule, a plurality of geographic locations along the direction of travel in the road information comprises:
invoking a preset electronic map to acquire a traveling path along the direction of travel of the road designated by the road information;
acquiring a plurality of geographic longitudes and latitudes on the traveling path with a certain longitude-latitude distance; and
determining the plurality of geographic longitudes and latitudes as a plurality of geographic locations.

9. The method according to claim 1, wherein information of the direction of travel is stored in GPS information of a picture.

10. The method according to claim 7, wherein the step of processing a plurality of target pictures of the same geographic location to obtain a positional target picture corresponding to the geographic location comprises:
deduplicating and splicing the plurality of target pictures to obtain a positional target picture corresponding to the geographic location.

11. The method according to claim 1, wherein the picture search request further comprises picture classification information, and the step of searching to obtain a plurality of target pictures matching the picture search request comprises:
searching to obtain a plurality of target pictures matching the road information, the direction of travel and the picture classification information.

12. The method according to claim 1, wherein the picture data are pushed by way of a video stream data packet in response to the picture search request.

13. The method according to claim 4, wherein when receiving a picture including the feature information and storing the picture into the picture database, the picture is stored using an extracted MD5 value of the picture as a picture name.

14. The method according to claim 4, wherein the feature information is stored in a data table, and an association is established between the feature information and the target picture; or
the feature information is stored in an attribute parameter corresponding to the target picture.

15.-39. (canceled)

40. A mobile terminal, comprising:
a memory having instructions stored thereon;
a processor configured to execute the instructions to perform operations for searching an on-the-way target picture, the operations comprising:
sending a picture search request including road information and a direction of travel via a remote interface;
receiving, via the remote interface, picture data returned by a server and sorted according to variation of different geographic locations included in the road information; and
displaying the returned picture data, wherein the picture data are sequentially displayed along the direction of travel of the road.

41. The mobile terminal according to claim 40, wherein the picture search request further comprises moment information and time range information.

42. The mobile terminal according to claim 40, wherein the operation of receiving, via the remote interface, picture data returned by a server and sorted according to variation of different geographic locations included in the road information comprises: receiving, via the remote interface, a storage webpage address of the picture data returned from the server.

43. The mobile terminal according to claim 40, wherein the operation of displaying the returned picture data comprises: displaying the picture data in a display window of a web page obtained by loading; or
downloading the picture data through the storage webpage address and locally play the picture data.

44. The mobile terminal according to claim 40, wherein the picture search request further comprises picture classification information.

45.-50. (canceled)

51. A non-transitory computer-readable medium having computer programs stored thereon that, when executed by one or more processors of an electronic device, cause the electronic device to perform operations for detecting website security, the operations comprising:
receiving a picture search request, wherein the picture search request comprises road information and a direction of travel;
searching to obtain a plurality of target pictures matching the picture search request, wherein the target pictures match both the road information and the direction of travel;
processing the plurality of target pictures according to different geographic locations included in the road information to obtain picture data sorted according to variation of the geographic locations and matching the picture search request and
pushing the picture data in response to the picture search request.
